(19) United States
(12) Patent Application Publication
(10) Pub. No.: US 2007/0199015 A1
(43) Pub. Date: Aug. 23, 2007

(54) System for deferred rights to restricted media

(75) Inventors: Lawrence Thomas Lopez, Cupertino, CA (US); Samuel Thomas Scott III, Los Gatos, CA (US); Shannon Vosseller, San Francisco, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/359,046

(22) Filed: Feb. 22, 2006

(51) Int. Cl. H04N 7/167; H04N 7/16

(52) U.S. Cl. 725/31; 725/25

(57) ABSTRACT

A software application program and method are disclosed for allowing blacked-out television content to be viewed when restrictions on the television content have been lifted. The present system may be part of a software platform for providing television content to subscribers via a broadband IP network service provider such as a telephone company. For situations where a content owner has made deferred rights to television content available, the present system employs a deferred rights management software application program for affecting the download and storage of restricted content to subscribers. The restricted content is downloaded to subscribers in an encrypted format, and remains locked and unusable by subscribers as long as the license restrictions last. When the license restrictions are lifted, the SMS 116 transmits decryption keys allowing decryption and viewing of the content.

### BACKGROUND

Television refers to a telecommunications system for the broadcast and reception of audio and video signals. Early television made use of terrestrial signal delivery, where radio frequency signals were delivered via open air radio waves. From there, cable television evolved where audio and video signals are delivered directly to a television set through fixed optical fibers and/or coaxial cables. The next major advance in television signal delivery came with satellite television, where telecommunications satellites in orbit around the earth deliver signals from the satellites to receiving dishes connected to television sets.

Traditionally, broadband service providers such as telephone companies have not participated in the television broadcast market. However, with the proliferation of internet protocols, and the expansion of broadband capabilities, broadband service providers are now able to compete with cable and satellite operators by delivering television to subscribers via the Internet. Microsoft TV, a division of Microsoft Corporation of Redmond, Wash., has developed a software platform referred to as Microsoft TV IPTV Edition (“IPTV”) which allows broadband service providers to acquire television broadcast television content, and distribute the television content to subscribers in a secure manner.

In one configuration, IPTV may be implemented by a set of server systems (each server system including one or more services). The first server system may be responsible for acquiring television signals and then retransmitting the signals to authenticated IPTV client devices. The second server system, referred to herein as a metadata server system, is responsible for authenticating IPTV client devices. The metadata server may make use of various known security authentication measures, such as security certificates and public key cryptography, to ensure that a requesting client device is an authorized IPTV client. Moreover, the metadata server system may maintain a subscriber management system (“SMS”) which is a software application program for managing subscriber account information including whether or not a given subscriber is authorized to receive requested television content.

Normally, signal broadcasters such as broadband IP networks receive an unrestricted license from content owners to broadcast content to the broadcaster's subscribers. However, from time to time, signal broadcasters receive only a limited, restricted license from content owners to transmit content. The most common example of a license restriction is a broadcast “blackout,” often associated with sporting events, where the television content owner restricts distribution rights unless certain criteria are met. For example, the National Football League (“NFL”) owns the rights to the televised broadcasts of NFL football games. The NFL has a policy where it will grant only a restricted license to signal broadcasters to retransmit NFL football games, under which restricted license any area within a 75 mile radius of an NFL stadium where a game is being played is blacked out unless tickets for that game are sold out some time before the game starts. Major League Baseball, the National Hockey League and other sports also have restrictions on the distribution rights of their television content unless certain criteria are met.

Thus, even though signal broadcasters like broadband IP networks receive the feed of restricted license television content, they are restricted from retransmitting the restricted content to subscribers that are subject to the restriction. At present, there is no system for signal broadcasters like IP networks to distribute content in a restricted area, even after the license restrictions have been lifted.

### SUMMARY

The present system, roughly described, relates to a software application program and method for allowing blacked-out television content to be viewed when restrictions on the television content have been lifted. The present system may be part of a software platform for providing television content to subscribers via a broadband IP network service provider, such as a telephone company. However, the present system may be deployed in a software platform in any telecommunications system capable of delivering television content via an IP network.

In some situations where a content owner has restricted the license given to signal broadcasters, resulting in blackouts to certain areas, the content owner may also grant “deferred rights” to the content. That is, the content owner agrees to remove the restrictions on the retransmission of content for some time after the time of its regularly scheduled retransmission.

For situations where a content owner has made deferred rights available to television content, the subscriber management system may further include a protocol for affecting the download and storage of restricted content to subscribers. The restricted content is downloaded to subscribers in an encrypted format, and remains locked and unusable by subscribers as long as the license restrictions last. When the license restrictions are lifted, the subscriber management system transmits decryption keys allowing decryption and viewing of the content. In addition to providing access to previously blacked out and lost content, the present system also provides an additional revenue stream to broadband service providers by allowing them to charge for television content that otherwise would not generate additional revenue.

The subscriber management system may include one or more application program interfaces allowing a service provider to enter the date and time when the content owner has indicated the restrictions end. Application program interfaces may also be provided allowing a service provider to enter a viewing rights policy of additional conditions which must be satisfied in order for the content to be viewed. Such additional conditions may include availability windows, expiration, play count and other conditions.

In operation, once a subscriber indicates a desire to receive deferred rights to restricted license television content, the subscriber management system may first authenticate the subscriber's client device, as well as whether the subscriber has access rights to the requested content. Once authentication is verified, the encrypted television content subject to the license restrictions may be downloaded and stored on the subscriber's client device(s). When the subscriber management system determines that the restrictions on the television content have been lifted, one or more decryption keys for the television content may be downloaded to the client device. Once the subscriber management system has downloaded the decryption keys and determines that any other applicable viewing rights conditions have been satisfied, the television content is decrypted and displayed to the subscriber in a normal format.

In alternative embodiments to the present system, the encrypted television content need not be stored on the subscriber's device(s). Television content to which deferred rights have been granted may alternatively be stored on servers administered by the broadband service provider, or a third party. In such embodiments, when the license restrictions are lifted, the encrypted content and the decryption keys may be downloaded to the client device(s).

### DESCRIPTION OF THE DRAWINGS

FIG. 1 is a block diagram of a broadband service provider network including a subscriber management system for providing deferred viewing rights to restricted license television content according to the present system.

FIG. 2 is a flowchart of a process for indicating the existence of deferred rights for restricted license television content and allowing a subscriber to select the deferred rights option.

FIG. 3 is a graphical representation of a program guide presenting a deferred rights option to a subscriber.

FIG. 4 is a graphical representation of a program guide including a pop-up window for listing deferred rights conditions.

FIG. 5 is a flowchart for the operations of the subscriber management system for authenticating and managing deferred rights to restricted license television content.

FIG. 6 is a block diagram of computer hardware for implementing embodiments of the present system.

### DETAILED DESCRIPTION

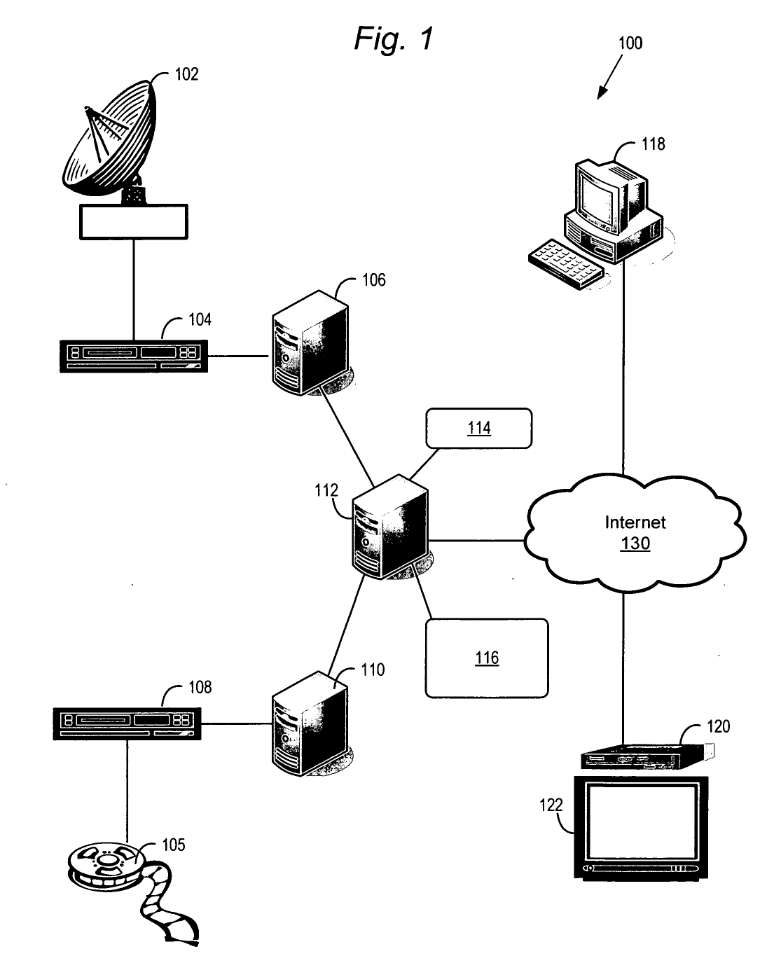

The present system will now be described with reference to FIGS. 1-6, which in embodiments relate to a software application program and method for allowing viewing of restricted license television content when restrictions on the television content have been lifted. In embodiments, the present system may be implemented as part of a software platform for transmitting and displaying audio and/or video signals over an internet protocol (“IP”) network such as for example IPTV from Microsoft Corporation of Redmond, Wash. It is understood however that the present system may be implemented in other networks and other software platforms in alternative embodiments. The audio and/or video content transmitted and managed by the present system is referred to herein as “television content.” However, it is understood that the present system may be used to transmit and manage other content, such as for example audio content transmitted over a radio or the like.

FIG. 1 illustrates a system for transmitting television signals over a broadband service provider network 100. Network 100 may be administered by a broadband service provider, such as for example telephone companies including Verizon, AT&T and others. The components of broadband service provider network 100 are generally known to the art, with the exception of features of the subscriber management system described hereinafter.

Audio and video signals from a live feed may be received in a receiver 102 from, for example, a telecommunications satellite (not shown). Receiver 102 (or a plurality of such receivers) may collect all live feed of the television content to be televised via the broadband service provider network 100. It is understood that receiver 102 may receive telecommunications signals from additional or other sources (such as cable or open air terrestrial radio waves). The signal from receiver 102 may be digitized and encrypted in an encoding device 104 and then stored for retransmission on an acquisition server 106 administered by the broadband service provider or a third party partner of the broadband service provider.

In addition to live feed, network 100 may also provide subscribers with a video on demand (“VOD”) option for receiving on demand video and other television content as selected by a subscriber. Accordingly, VOD content 105 may be digitized and encrypted in an encoding device 108 of known design, and then stored for retransmission on a VOD server 110 administered by the broadband service provider or a third party partner of the broadband service provider.

Transmission of television content via network 100 may include retransmission from acquisition server 106, VOD server 110 and metadata server 112 (discussed hereinafter) to content display device 118 and/or to set top box 120, which may be connected to a display such as a television set 122. Transmission of television content, as well as metadata (such as program schedule and other information), may be transmitted to device 118 and set top box 120 via the Internet 130. In embodiments, broadband network 100 may download television content and other information to client devices (computing device 118 and set top box 120) at a rate of between 3 and 30 megabytes per second. It is understood that the data rate may be lower or higher than that in alternative embodiments of the present system.

Content display device 118 may be any sort of computing device including an associated display, such as for example a desktop computer, a laptop computer, a tablet computer, a hand-held computer, a gaming device, such as an XBox® gaming device from Microsoft Corporation, of Redmond, Wash., a mobile telephone and a personal digital assistant. Computing device 118 and set top box 120 may include client software as is known in the art for accessing network 100 and receiving the television content and metadata.

Broadband service provider network 100 further includes a metadata server 112 having, for example, a programming guide 114 and a subscriber management system (“SMS”) 116. Programming guide 114 is an application program for performing tasks such as obtaining scheduling information for television content available via network 100. Programming guide 114 further includes or communicates with a data store for storing the scheduling information. The application program for programming guide 114 also provides a graphical user interface to subscribers over their television set or other content viewing device, through which subscribers may choose television content for viewing and interact with SMS 116 and metadata server 112.

The SMS 116 is a software application program which performs a variety of functions for managing subscriber interaction with the broadband service provider network 100. In general, SMS 116 manages security features, subscriber account information, and a viewing rights policy including a deferred rights protocol to restricted license content according to the present system. Each of these features of SMS 116 is explained in greater detail below.

Several levels of security may be implemented with the present system for ensuring that television content over network 100 is properly and securely delivered only to those entitled to receive the content. First, the client devices 118, 120 may be authenticated by SMS 116 using security certificates and/or other known security measures. Second, SMS 116 stores subscriber identification and verification information for authenticating a subscriber. Third, as indicated above, digital television content may be encrypted during transmission, and then decrypted upon receipt of the proper decryption keys within the subscriber's devices. A variety of known encryption and decryption schemes may be utilized, such as for example the advanced encryption standard (AES), or RSA and other known public key encryption schemes.

SMS 116 may additionally include information relating to a subscriber's account, history and billing information. The SMS 116 manages account information, provides requested account and services information and ensures that an account is in good standing when delivering content.

The service provider may maintain a list of all viewing rights to the television content it offers, referred to herein as a viewing rights policy. The viewing rights policy may also be implemented by SMS 116 to ensure that any conditions on the delivery of television content are satisfied before the content is made available for subscriber viewing. For example, the viewing rights policy tracks package and service enrollments to ensure that a subscriber entitled to any requested television content before delivering the requested content. The viewing rights policy of the SMS 116 may also track parental controls and other subscriber-generated restrictions placed on content delivery.

Moreover, in accordance with the present system, the viewing rights policy may include license restrictions on television content, as well as the conditions under which subscribers are granted deferred rights to restricted license television content. As described in the Background section, from time to time an owner of television content may grant signal broadcasters (terrestrial, cable, satellite or broadband IP network) only a restricted license to broadcast its content. For example, the NFL may blackout transmission of a football game to viewers near a stadium where insufficient numbers of tickets have been sold. A signal broadcaster must abide by these license restrictions once they are notified of the restriction. Thus, for example, the broadband service provider network 100 will receive a feed, but then must restrict its retransmission only to subscriber devices that are not subject to the blackout restriction. The term “license restrictions” as used herein may refer to any type of restrictions placed on a broadcaster by a content owner, its agent or any third party regarding the retransmission of content such as television content.

There may be several different types of license restrictions an owner or others may place on television content. Some restrictions relate to whether and under what conditions television content is to be blacked out at the time of its scheduled broadcast. Other restrictions relate to the whether and under what conditions deferred rights to the blacked out content are granted after the black out is over. Each of these restrictions may be part of the viewing rights policy. SMS 116 may include one or more application program interfaces (APIs) through which each of these different restrictions may be entered into metadata server 112 so that they may be managed by SMS 116.

For example, SMS 116 may include an API to subdivide a geographic area. This API allows the service provider to blackout certain areas according to the license restrictions on the television content. SMS 116 may additionally include an API temporally classifying subscribers. Thus, for example, an owner may restrict television content so only those who have been subscribers to a particular service for a particular period of time receive the television content. SMS 116 may further include an API for dividing up subscribers according to the type or number of client set top boxes 120 used by the subscriber. Thus, for example, an owner may restrict television content so that only subscribers using set top boxes manufactured by, e.g., Samsung receive its television content. It is understood that additional APIs may be provided allowing owners of television content to place further types of restrictions on their television content. Once the license restrictions have been entered into SMS 116, the restrictions may be stored on a database associated with SMS 116.

In addition to license restrictions, the viewing rights policy may further include deferred rights that are granted to view restricted license television content. For example, in the instance of the NFL blacking out a football game, the NFL may additionally indicate to the service provider that the service provider may televise the football game after it is over, or 24 hours later.

The deferred rights may be unconditional, i.e., at a designated date and time, all license restrictions to the content are lifted. Alternatively, the deferred rights may be conditional, i.e., at a designated date and time, television content may be broadcast to previously blacked out subscribers, but only under certain conditions. These conditions may relate to a specified window of time within which the restricted content may be viewed, with rights again being lost upon expiration of the window. These conditions may further relate to a maximum number of times restricted content may be viewed after the blackout is lifted. Other conditions are contemplated. SMS 116 may further include one or more APIs through which the service provider may enter the deferred rights, as well as any conditions placed on the deferred rights.

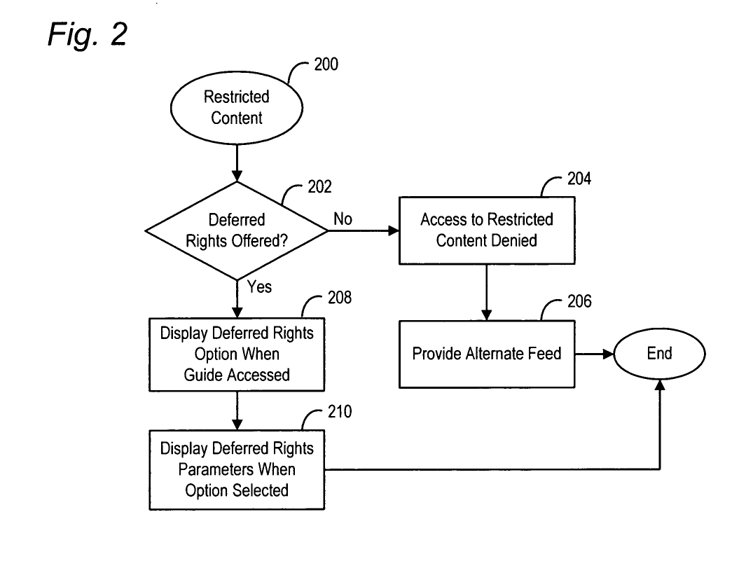

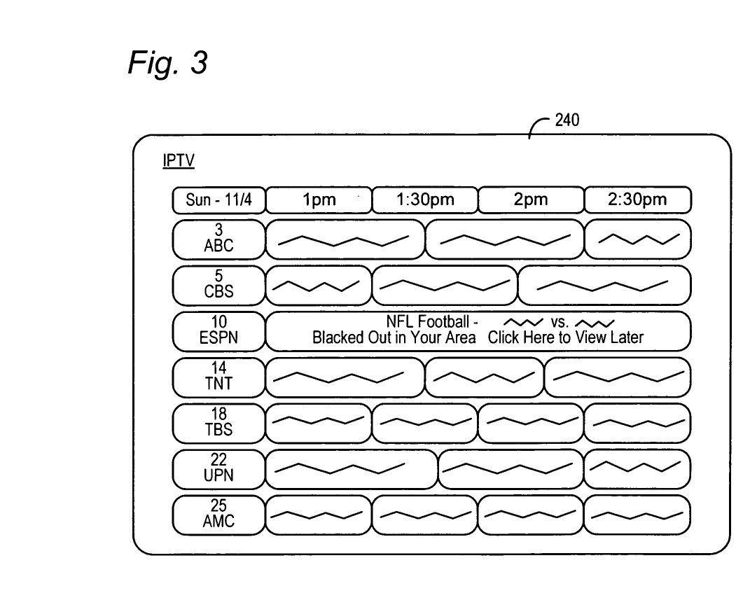

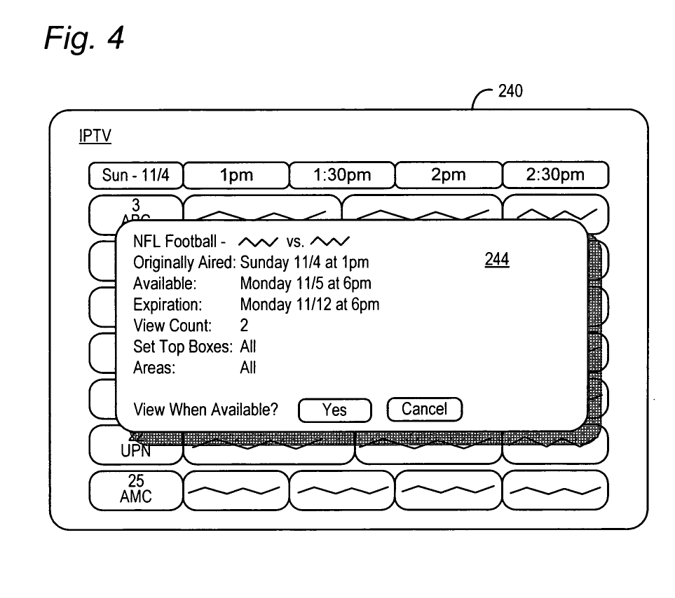

A process according to the present system for alerting a subscriber to the option of deferred rights viewing of television content will now be described with reference to the flowchart of FIG. 2 and the graphical representation of a program guide user interface of FIGS. 3 and 4. Where license restrictions are placed on television content (step 200), the SMS 116 checks whether deferred rights are available for the restricted license television content (step 202). If no deferred rights have been offered by the content owner, access to the restricted television content is denied (step 204). Access to the restricted television content may be denied in one of two ways. In the first embodiment, SMS 116 may block the download of the restricted television content to computing device 118 and/or set top box 120/television 122. Alternatively, as all television content is transmitted to devices 118, 120 in encrypted form, the television content subject to the license restrictions may be downloaded, but the decryption keys to the encrypted television content are withheld. Without the decryption keys, the television content remains locked and not useable.

Where television content for a subscriber is subject to restrictions and blacked out at the scheduled time, a service provider may provide an alternate feed (step 206) for the subscriber to view in the place of the restricted television content. Step 206 of providing an alternate feed may be omitted in embodiments of the present system.

If deferred rights to restricted license television content are instead offered in step 202, the program guide may indicate the options for viewing the restricted television content when license restrictions are lifted (step 208). For example, FIG. 3 shows a graphical illustration 240 of a sample program guide user interface presented to subscribers for selecting television content to be viewed. Sample program guide 240 in FIG. 3 shows an example of a football game that is blacked out in a particular area of the computing device 118 or set top box 120/television 122 displaying the program guide 240. However, the owner of the television content has provided deferred rights to view the television content at a time when restrictions on the television content have lifted. Thus, program guide 240 may include an indication of deferred rights, such as for example by displaying the words “click here to view later.” It is understood that other indicators of deferred rights may be provided in alternative embodiments of the present system.

If a subscriber selects the deferred rights option, the program guide may display to the subscriber the deferred rights parameters and conditions under which the deferred rights have been granted (step 210). For example, if the subscriber selects the option on the program guide 240 of FIG. 3 for deferred rights to restricted television content, the program guide 240 may present a pop-up window 244 such as shown in FIG. 4. Pop-up window 244 may have a description of the restricted television content, an indication of when the restricted television content originally aired and when restrictions for viewing the television content are lifted.

It may be that an owner of the television content has only allowed for a window of time in which television content may be viewed. If so, pop-up window 244 may also display the time when rights to the restricted television content expire. An owner of television content may further condition that restricted television content may only be viewed a set number of times. If so, the view count may also be indicated in pop-up window 244. Any other conditions under which the restrictions on the television content are lifted may also be presented in pop-up window 244, such as for example the type of set top boxes allowed to receive the television content and geographic areas allowed to receive the television content. It is understood that more or less conditions may be set forth in pop-up window 244 than are shown in FIG. 4. A subscriber may also be asked to confirm whether or not they wish to select deferred rights to the restricted television content.

In embodiments, there may be a charge to the subscriber to purchase the deferred rights to view the restricted television content. Thus, the present system also provides an additional revenue stream to broadband service providers by allowing them to charge for television content that otherwise would generate no additional revenue. It is understood that the deferred rights have been provided to subscribers free of charge in alternative embodiments. It is also understood that a drop-down menu or other graphical object may be displayed on program guide 240 instead of a pop-up window.

It may happen that no deferred rights are offered to television content at the scheduled time the content is to be televised, but such deferred rights become available to service provider licensees at a later time. In such an event, the SMS 116 may offer deferred rights to the television content when the deferred rights become available. For example, a pop-up window on program guide 240, or other notification on the display, may be used to notify subscribers of the newly available deferred rights to restricted television content.

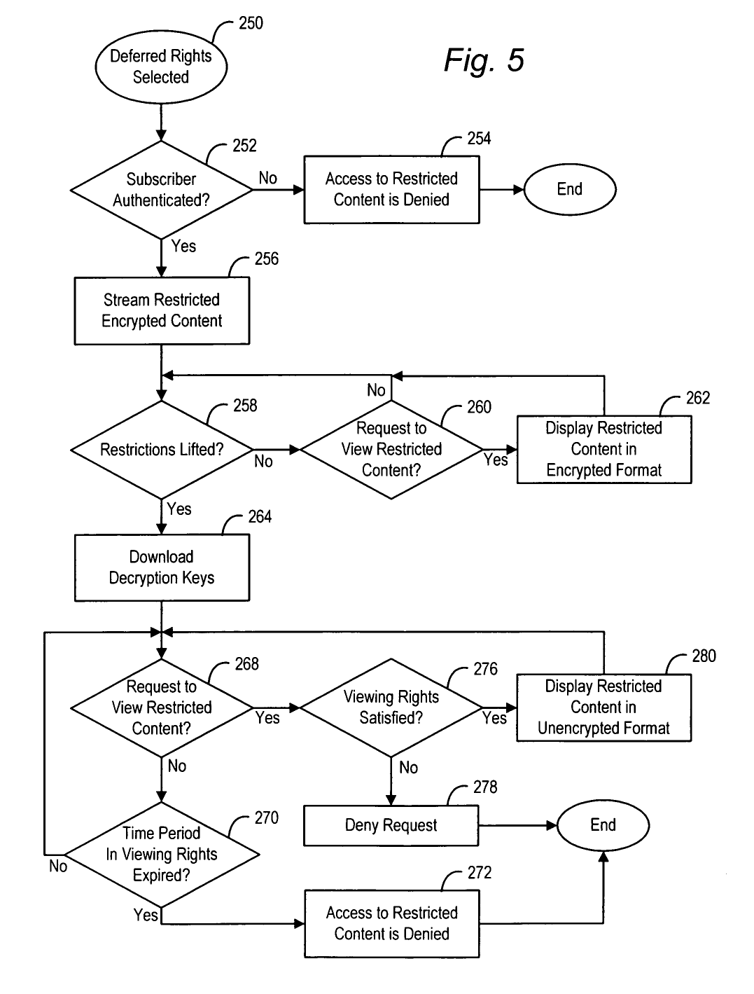

Once a subscriber has indicated they wish to receive deferred rights to restricted license television content, the SMS 116 then authenticates the subscriber and manages the deferred rights viewing process as explained with reference to the flowchart of FIG. 5. In particular, when deferred rights are selected (step 250), the SMS system 116 may first authenticate a client device and/or subscriber (step 252). As indicated above, known security measures such as for example security certificates may be used to authenticate a particular client device with the metadata server 212. If a subscriber is not authenticated in step 252, access to the restricted television content may be denied (step 254).

If, on the other hand, a subscriber is authenticated in step 252, the television content subject to the license restrictions may be downloaded and stored on the subscriber's computing device 118 and/or set top box 120 (step 256). Notably, the television content that is downloaded to and stored on a subscriber's device in step 256 is encrypted and is not usable by the subscriber unless and until the decryption data, such as decryption keys, are downloaded to the subscriber's device as explained hereinafter. Thus, all applicable license restrictions placed on the viewing of the television content by the television content owner or others are adhered to.

As indicated above, the subscriber may be provided with the option to view an alternative feed in the event of restricted content. If an authenticated subscriber elects to download the restricted television content for later viewing, additional bandwidth may be used to download both the alternative feed and the restricted television content.

In step 258, the SMS 116 detects whether the restrictions on the television content have been lifted. If they have not, a subscriber request to view the restricted television content (step 260) may result in the television content being displayed in an encrypted, unusable format (step 262). As an alternative to step 262, a subscriber may be denied access to the restricted television content altogether.

If it is determined in step 258 that restrictions on the television content have been lifted, one or more decryption keys for the encrypted television content may be downloaded to the client device in step 264. In describing that the decryption keys are downloaded “when” the restrictions have been lifted, this may mean the actual time designated for the lifting of the license restrictions. However, in alternative embodiments, this may mean some time period (e.g., a few minutes or longer) before the restrictions have been lifted, or some time period (e.g., a few minutes or longer) after the restrictions have been lifted. Thus, in embodiments, it is not necessary under the present system that the decryption keys be downloaded precisely at the time when the license restrictions on the television content are lifted.

In embodiments, decryption keys may change after preset time intervals, such as for example every one-half hour. Thus, if attempt is made to circumvent the security features and decipher a decryption key, even if successful, the decryption key will only be good for a short period of time before it changes. Once it changes, access to the unencrypted television content is again denied unless the proper key has been downloaded. In step 264, the number of decryption keys downloaded may be sufficient to decrypt the television content for the entire length of the broadcast of the television content subject to the restriction.

In step 268, the SMS 116 looks for a request by a subscriber to view the restricted license television content. As indicated above, in some instances, a window of time may be defined by the television content owner within which the television content may be viewed. In such instances, if the allowed window of time passes before the subscriber has viewed the restricted television content (step 270), then access to the restricted television content is denied (step 272). If the time period within which to view the television content has not yet expired, or if there is no expiration on the time within which the television content may be viewed, the SMS 116 returns to step 268 to look for a request to view the restricted television content.

In step 268 if a subscriber requests to view the restricted television content, the SMS 116 next determines whether the viewing rights have been satisfied in step 276. For example, in addition to the expiration window, there may be additional conditions on deferred rights, including for example restrictions on the number of times television content may be viewed. If a subscriber has reached the play count limit, or if any other conditions of the viewing rights policy are not satisfied, the subscriber's request to view the television content is denied in step 278. On the other hand, if the SMS 116 has downloaded the decryption keys and determined that all viewing rights conditions have been satisfied, the television content is displayed to the subscriber in a “normal” unencrypted format in step 280.

In embodiments described above, television content, whether subject to license restrictions or otherwise, may be stored in memory associated with subscriber computing device 118 and/or subscriber set top box 120. In alternative embodiments to the present system, it is understood that the television content need not be stored on the subscriber's device(s). Television content to which deferred rights have been granted may alternatively be stored on servers administered by the broadband service provider, or a third party. In such embodiments, when the license restrictions are lifted, the encrypted content and the decryption keys may be downloaded to the client device(s). Alternatively, the content may be decrypted with the keys at the remote server, and the decrypted television content downloaded to the client device(s).

While a SMS 116 has been described as part of the software platform delivered by a broadband service provider such as a telephone company, it is understood that the SMS 116 may be deployed in a software platform in any telecommunications system capable of delivering television content via an IP network.

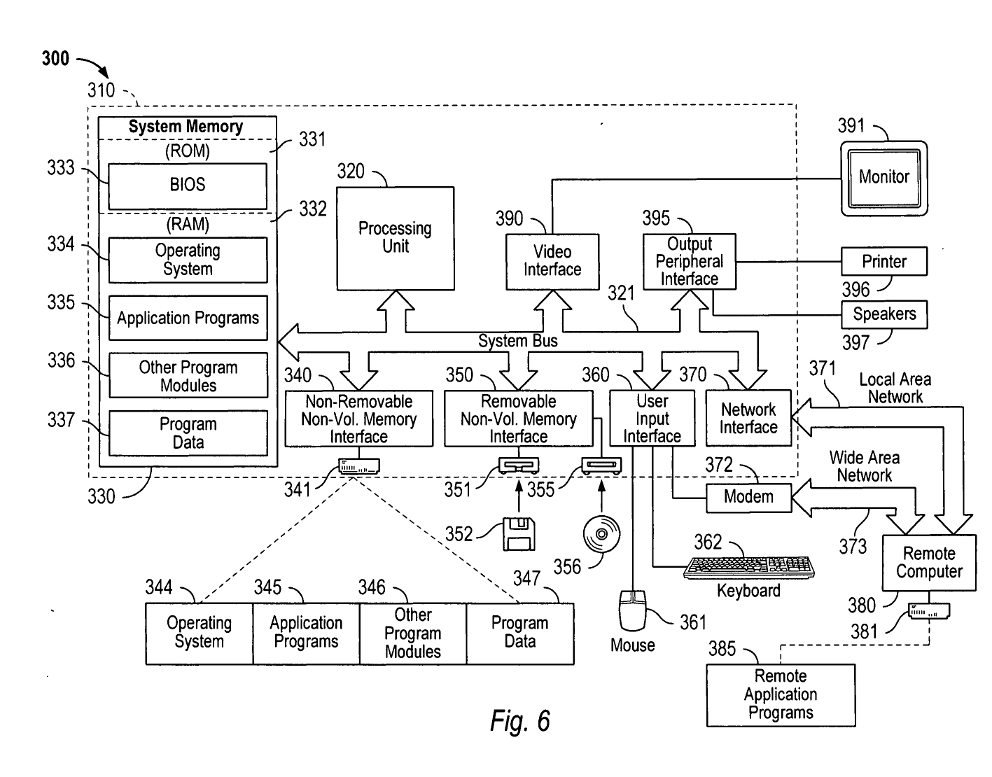

FIG. 6 illustrates an example of a suitable general computing system environment 300 that may comprise any computing device or processing device shown herein on which the inventive system may be implemented. The computing system environment 300 is only one example of a suitable computing environment and is not intended to suggest any limitation as to the scope of use or functionality of the inventive system. Neither should the computing system environment 300 be interpreted as having any dependency or requirement relating to any one or combination of components illustrated in the exemplary computing system environment 300.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 6, an exemplary system for implementing the inventive system includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 may include a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile discs (DVD) or other optical disc storage, magnetic cassettes, magnetic tape, magnetic disc storage or other magnetic storage devices, or any other medium which can be used to store the desired information and which can be accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 330 includes computer storage media in the form of volatile and/or nonvolatile memory such as ROM 331 and RAM 332. A basic input/output system (BIOS) 333, containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 6 illustrates operating system 334, application programs 335, other program modules 336, and program data 337.

The computer 310 may also include other removable/non-removable, volatile/nonvolatile computer storage media. By way of example only, FIG. 6 illustrates a hard disc drive 341 that reads from or writes to a non-removable, nonvolatile magnetic media and a magnetic disc drive 351 that reads from or writes to a removable, nonvolatile magnetic disc 352. Computer 310 may further include an optical media reading device 355 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 341 is typically connected to the system bus 321 through a non-removable memory interface such as interface 340; magnetic disc drive 351 and optical media reading device 355 are typically connected to the system bus 321 by a removable memory interface, such as interface 350.

The drives and their associated computer storage media discussed above and illustrated in FIG. 6 provide storage of computer readable instructions, data structures, program modules and other data for the computer 310. In FIG. 6, for example, hard disc drive 341 is illustrated as storing operating system 344, application programs 345, other program modules 346, and program data 347. These components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and a pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port or a universal serial bus (USB). A monitor 391 or other type of display device is also connected to the system bus 321 via an interface, such as a video interface 390. In addition to the monitor 391, computers may also include other peripheral output devices such as speakers 397 and a printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 6. The logical connections depicted in FIG. 6 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 6 illustrates remote application programs 385 as residing on memory device 381. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

1. A method of providing content for a client device via a network, the content being subject to a license restriction, the method comprising the steps of:
a) transmitting the content to the client device in a format which prevents viewing of the content on a display associated with the client device; and
b) enabling the client device to present the content on the display in a normal format that allows viewing of the content when the license restriction on the content has been lifted.

2. A method as recited in claim 1, wherein said step b) of enabling the client device to present the content in a normal format that allows viewing of the content when the license restriction on the content has been lifted comprises the step of downloading one or more decryption keys to the client device when the license restriction on the content has been lifted.

3. A method as recited in claim 1, further comprising the step c) of authenticating a client device prior to enabling the client device in said step b).

4. A method as recited in claim 1, further comprising the step c) of disabling the client device from presenting content in a normal format if a window during which the restrictions were lifted has expired.

5. A method as recited in claim 1, further comprising the step c) of presenting a graphical user interface over the display including an option to view the content when the license restriction on the content has been lifted.

6. A method as recited in claim 5, said step a) of transmitting the content to the client device being performed upon selecting the option to view the content when the license restriction on the content has been lifted in said step c).

7. A method as recited in claim 1, wherein the content is television content.

8. A computer-readable medium having computer-executable instructions for programming a processor to perform a method of providing content for a client device via a network, the content being subject to a license restriction, the method comprising the steps of:
a) storing the content in an encrypted format; and
b) deferring decryption of the content until the license restriction on the viewing of the content has been lifted.

9. A computer-readable medium as recited in claim 8, further comprising the step c) of authenticating the client device prior to said step a) of storing the content in an encrypted format.

10. A computer-readable medium as recited in claim 8, said step a) of storing the content in an encrypted format comprising the step of storing the content on a storage device associated with the client device.

11. A computer-readable medium as recited in claim 8, said step a) of storing the content in an encrypted format comprising the step of storing the content on a storage device remote from the client device and connected to the client device via the Internet.

12. A method of providing content for a client device via an IP network, the method comprising the steps of:
a) receiving one or more license restrictions on the rights to view the content;
b) receiving one or more conditions which must be satisfied in order for the one or more restrictions to be lifted and the content to be normally displayed on a display associated with the client device;
c) storing the content in an encrypted format; and
d) enabling the client device to present the content in an unencrypted format on the display when the one or more conditions of said step b) are satisfied.

13. A method as recited in claim 12, wherein said step b) of receiving one or more conditions which must be satisfied in order for the restrictions to be lifted and the content to be normally displayed on the display comprises the step of receiving an indication that a preset period of time must pass before the one or more restrictions are lifted.

14. A method as recited in claim 12, wherein said step b) of receiving one or more conditions which must be satisfied in order for the restrictions to be lifted and the content to be normally displayed on the display comprises the step of receiving a window having a start time and an end time within which content can be viewed.

15. A method as recited in claim 12, wherein said step b) of receiving one or more conditions which must be satisfied in order for the restrictions to be lifted and the content to be normally displayed on the display comprises the step of receiving a maximum number of times the content may be displayed.

16. A method as recited in claim 12, wherein said step b) of receiving one or more conditions which must be satisfied in order for the restrictions to be lifted and the content to be normally displayed on the display comprises the step of authenticating the client device.

17. A method as recited in claim 12, wherein said step d) of enabling the client device to present the content in an unencrypted format on the display when the one or more conditions of said step b) are satisfied comprises the step of downloading one or more decryption keys to the client device for decrypting the content.

18. A method as recited in claim 12, said step c) of storing the content in an encrypted format comprising the step of storing the content on a storage device associated with the client device.

19. A method as recited claim 12, said step c) of storing the content in an encrypted format comprising the step of storing the content on a storage device remote from the client device and connected to the client device via the Internet.

20. A method as recited in claim 12, wherein said step d) comprises the steps of downloading the encrypted content from the storage device to the client device, downloading a decryption key to the client device, and applying the decryption key to the encrypted content to decrypt the content.
